(19) United States
(12) Patent Application Publication
(10) Pub. No.: US 2024/0291144 A1
(43) Pub. Date: Aug. 29, 2024

(54) THINNED ARRAY FED REFLECTOR AND BEAM PEAK ADJUSTMENT METHOD THEREOF

(71) Applicant: VIASAT, INC., CARLSBAD, CA (US)

(72) Inventor: Maria Carolina Vigano, Lausanne (CH)

(21) Appl. No.: 18/567,430

(22) PCT Filed: Jun. 10, 2022
(86) PCT No.: PCT/US2022/033113

§ 371 Date: Dec. 6, 2023

Related U.S. Application Data
(60) Provisional application No. 63/209,149, filed on Jun. 10, 2021.

(51) Int. Cl. H01Q 3/24; H01Q 19/13; H01Q 19/17

(52) U.S. Cl. CPC H01Q 3/245; H01Q 19/132; H01Q 19/175

(57) ABSTRACT

A method for adjusting a pointing direction of an antenna beam involves forming a beam with a reflector antenna including a reflector and a feed, the feed including an array of N antenna elements, by activating a first set of antenna elements among the N antenna elements. A signal metric of a signal communicated via the beam is measured. In an iterative fashion, a pointing direction of the beam is adjusted at least in part by activating a different set of antenna elements among the N antenna elements, and the signal metric is re-measured with each iterative adjustment. A final pointing direction and associated final set of antenna elements are selected for operation of the reflector antenna based on the signal metric measurements.

### TECHNICAL FIELD

This disclosure relates generally to reflector antennas and more particularly to beam peak position adjustment in reflector antennas.

### Discussion of Related Art

In a point-to-point wireless communications link, it is desirable to “peak” the receive side antenna beam (a first antenna's beam) with respect to the transmit side beam (a second antenna's beam) to maximize the receive signal strength and quality. In other words, it is beneficial to spatially align the peak of a “receive beam” formed based on the receiving antenna characteristics with the peak of the transmit side beam. One prominent example is in satellite signal communications in which a residential reflector antenna receives a satellite signal broadcast. In high frequency bands, such as in Kₐ band, the reflector antenna forms a narrow beam, e.g., having a 3 dB beamwidth of 1° or less, such that small beam mispointing errors can lead to significant signal loss. Such mispointing errors may occur upon initial use of the reflector antenna due to imperfect installation, and/or during later use of the reflector antenna, e.g., due to mechanical shifting of the feed illuminating the reflector, as a function of environmental conditions.

One approach to the fine tuning of the beam peak position employs a control system to mechanically tilt the reflector antenna's feed according to a predetermined sequence until a requisite signal metric is met. However, this type of system adds to the antenna complexity and may be prone to mechanical failure when environmental conditions change.

### SUMMARY

In an aspect of the present disclosure, a method for adjusting a pointing direction of an antenna beam involves forming a beam with a reflector antenna including a reflector and a feed, the feed including an array of N antenna elements, by activating a first set of antenna elements among the N antenna elements. A signal metric of a signal communicated via the beam is measured. In an iterative fashion, a pointing direction of the beam is adjusted at least in part by activating a different set of antenna elements among the N antenna elements, and the signal metric is re-measured with each iterative adjustment. A final pointing direction and associated final set of antenna elements are selected for operation of the reflector antenna based on the signal metric measurements.

In another aspect, a reflector antenna includes: a reflector and a feed including an array of N antenna elements, the feed being positioned to illuminate the reflector; a combiner/divider coupled between the N antenna elements and an input/output port of the antenna system; signal metric measurement circuitry; and a controller. The controller cooperates with the signal metric measurement circuitry to perform the operations delineated above to iteratively adjust the pointing direction of the beam by, in turn, activating different sets of antenna elements among the N antenna elements and measure the signal metric, and thereafter select a final set of antenna elements for operation of the reflector antenna based on the signal metric measurements.

### BRIEF DESCRIPTION OF THE DRAWINGS

The above and other aspects and features of the disclosed technology will become more apparent from the following detailed description, taken in conjunction with the accompanying drawings in which like reference characters indicate like elements or features. Various elements of the same or similar type may be distinguished by annexing the reference label with an underscore/dash and second label that distinguishes among the same/similar elements (e.g., _1, _2), or directly annexing the reference label with a second label. However, if a given description uses only the first reference label, it is applicable to any one of the same/similar elements having the same first reference label irrespective of the second label. Elements and features may not be drawn to scale in the drawings.

FIG. 1 is a perspective view of an array-fed reflector antenna according to an embodiment.

FIG. 2 illustrates examples of different activatable sets of antenna elements within a feed of the reflector antenna, and respective pointing directions of beams that they may form.

FIGS. 3A and 3B each show respective examples of activatable sets of antenna elements in the reflector antenna feed.

FIG. 4 illustrates another example of activatable sets of antenna elements in the reflector antenna feed.

FIG. 5A schematically illustrates example components of the antenna feed and switching states of switches to activate a first set of antenna elements.

FIG. 5B shows switching states of switches in the example antenna feed to activate a second set of antenna elements.

FIGS. 6A, 6B, 6C, 6D and 6E depict respective examples of front-end elements in the antenna feed.

FIG. 7 schematically illustrates another example of an antenna feed that may be utilized in the reflector antenna, according to another embodiment.

FIG. 8 schematically illustrates example components of an antenna feed with interleaved transmit and receive antenna elements, that may be utilized in the reflector antenna according to an alternative embodiment.

FIG. 9 is a flow diagram of a method for adjusting a pointing direction of an antenna beam, according to an embodiment.

FIG. 10 is a flow diagram depicting further example pointing direction adjusting operations in the method of FIG. 9, subsequent to an initial set-up.

FIG. 11A is a perspective view of an example antenna feed employing slotted antenna elements that may be utilized in the reflector antenna.

FIG. 11B depicts the antenna feed of FIG. 11A with internal excitation couplers, each for electromagnetically exciting a set of the slots and implementing spatially overlapping beamforming.

FIG. 11C is a schematic diagram of the antenna feed of FIG. 11B, and illustrates one example of activating a subset of antenna elements.

FIG. 11D is a schematic diagram of the antenna feed of FIG. 11B, and illustrates another example of activating a subset of antenna elements.

### DETAILED DESCRIPTION OF EMBODIMENTS

The following description, with reference to the accompanying drawings, is provided to assist in a comprehensive understanding of certain exemplary embodiments of the technology disclosed herein for illustrative purposes. The description includes various specific details to assist a person of ordinary skill in the art with understanding the technology, but these details are to be regarded as merely illustrative. For the purposes of simplicity and clarity, descriptions of well-known functions and constructions may be omitted when their inclusion may obscure appreciation of the technology by a person of ordinary skill in the art.

Herein, the phrase “communicating signals” (or like forms) encompasses unidirectional and bidirectional communication. Thus, when a first device communicates signals with a second device, the first device transmits signals to and/or receives signals from the second device.

Herein, the phrase “combining/dividing” or like forms means combining and/or dividing.

Herein, the slash symbol “/” connecting two items signifies and/or (“and” or “or”), unless the context indicates otherwise. In other words, both items are present in one example, but only one of the items is present in another example.

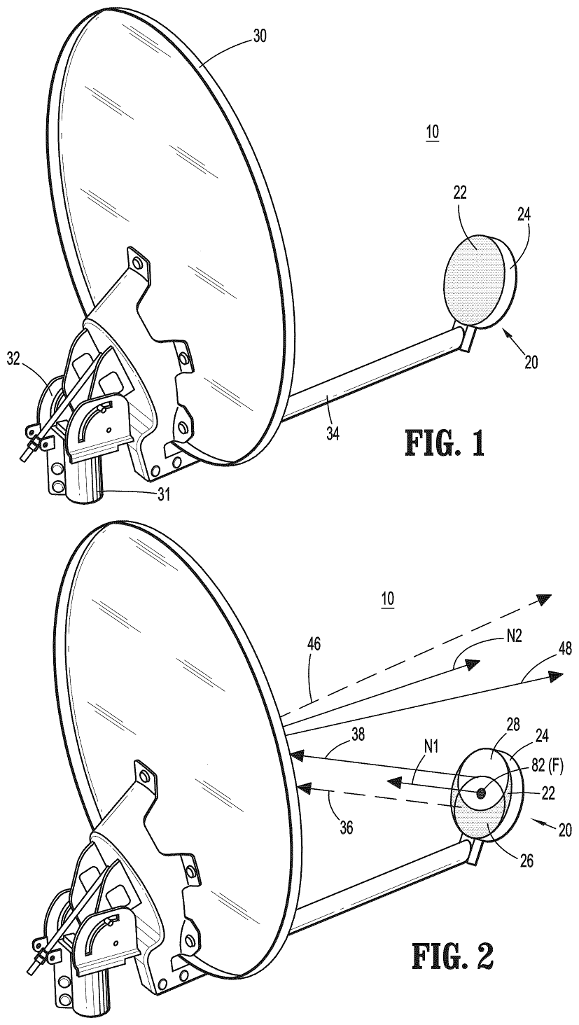

FIG. 1 is a perspective view of an array-fed reflector antenna assembly, 10, according to an embodiment (hereafter, “reflector antenna” or just “antenna” 10). Antenna 10 includes a reflector 30 such as a parabolic reflector, which may be center-fed or offset-fed by an array feed 20. Array feed 20 includes an antenna array 22 and a circuit assembly 24 containing at least RF front-end electronics, disposed behind antenna array 22. Array feed 20 may be fixedly coupled to reflector 30 via a support boom 34. A mounting bracket assembly 32 may be coupled between reflector 30 and a support pier 31. Support pier 31 may fixedly mount reflector antenna 10 to a surface such as a roof or an exterior wall of a building or other terrestrial structure.

Array feed 22 is positioned in or near the focal plane of the reflector and oriented in relation to reflector 30 such that antenna 10 produces a beam for communication (transmit, receive, or transmit and receive) with an intended target such as a satellite. In a typical embodiment, a central point of array feed 22 is positioned at or near the focal point of reflector 30. In examples in which the communication includes transmit and receive, the “beam” formed by antenna 10 may be considered to include a “receive beam” (used to receive a first signal from the target) and a “transmit beam” (used to transmit a second signal to the target). However, if different respective frequencies or polarizations are used for uplink signals (transmitted from antenna 10) and downlink signals (received by antenna 10), the receive beam may differ slightly from the transmit beam in terms of beamwidth and pointing direction.

In some embodiments, antenna 10 is a user terminal antenna assembly for residential use, configured to communicate signals with one or more satellites at microwave/millimeter wave frequencies. As such, antenna 10 may form a narrow pencil (rotationally symmetric) beam, e.g., with a 3 dB beamwidth under 1° in some embodiments. Thus, small antenna beam pointing errors may lead to significant signal loss.

Mounting bracket assembly 32 may be used to coarsely point the beam at the intended target. During the coarse pointing an initial set of antenna elements may be activated and a signal metric measured to assist in the coarse pointing. Mounting bracket assembly 32 may include bolts that can be loosened to permit antenna assembly 10 to be moved in azimuth, elevation and skew. For example, an installer may determine an approximate elevation angle of a mounting surface to which support pier 31 is mounted. The installer may also know the approximate direction of the intended target with respect to the installation location based on predetermined information and/or signal measurements at the site. The installer may then manipulate mounting bracket assembly 32 in azimuth/elevation/skew to coarsely point the beam at the target and then secure the mounting bracket assembly 32. In the process of the coarse pointing of the antenna beam, all the antenna elements of array 22 of feed 20 are activated, or only a subset of the antenna elements of array 22 of feed 20 located near focal point 82 (F) of the reflector is activated.

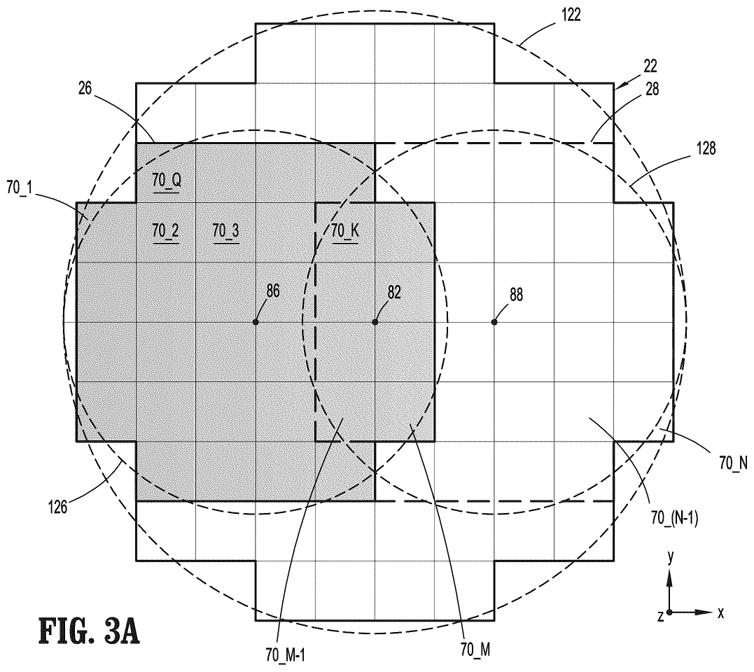

FIG. 2 illustrates examples of different “activatable” subsets of antenna elements, 26 and 28, within the array 22 of feed 20, and respective pointing directions of beams they may produce. In a typical embodiment, only some of the antenna elements of array 22 are activated at any given time; each set of activated antenna elements may therefore be referred to as a subset of antenna elements. At least some of the antenna elements of array 22 may be individually activatable, i.e., selectively activated and deactivated. An “activated” antenna element is an antenna element that operates normally in an array and is not “shut off” by an effective opening of a switching element in a signal path coupled to the antenna element. (An amplifier is one example of the switching element. When bias is applied normally, the switching element is turned on; when bias is removed, the switching element is off.) In other words, an activated antenna element contributes to forming a beam of the antenna, while a deactivated antenna element is precluded from contributing to forming the beam. Thus, an activated antenna element transmits signal energy in the transmit direction and/or receives signal energy in the receive direction that contributes to a composite receive signal received by antenna 10. A switching element within a signal path coupled to a respective antenna element of array 22 may be on-off controlled by a controller located within circuit assembly 24 or elsewhere. When the switching element is turned on (closed), the signal path is closed, whereby the antenna element is activated and operates normally, contributing to the formation of the overall beam of antenna 10. In other words, the activated antenna element is part of an active, beam forming subset of array 22. When the switching element is opened, the antenna element is deactivated and no longer part of an active subset, and does not contribute to forming the beam (with the exception of a possible slight impact on the beam's gain and pattern due to any parasitic excitation, reflections causing mismatch, etc.).

As noted above, an amplifier is one example of the switching element. Another example of the switching element is a series connected switch. Alternatively, an array element can be effectively “shut off” by reducing the amplitude of the RF signal fed into the element to an effectively negligible level, such as −20 dB compared to the most-activated elements in the array. This may be done by embodying the switching element as either a variable attenuator or a modulation modifier.

Thus, an activated antenna element transmits signal energy in the transmit direction and/or receives signal energy in the receive direction that contributes to a composite receive signal received by antenna 10. A switch within a signal path coupled to a respective antenna element of array 22 may be on-off controlled by a controller located within circuit assembly 24 or elsewhere. When the switch is turned on (closed) or the amplitude of the RF signal fed into the element is reduced to an effectively negligible level, the signal path is closed, whereby the antenna element is activated and operates normally, contributing to the formation of the overall beam of antenna 10. In other words, the activated antenna element is part of an active, beam forming subset of array 22. When the switch is opened or the amplitude of the RF signal fed into the element is above an effectively negligible level, the antenna element is deactivated and no longer part of an active subset, and does not contribute to forming the beam (with the exception of a possible slight impact on the beam's gain and pattern due to mutual electromagnetic coupling-induced parasitic excitation, reflections causing mismatch, etc.).

The above-mentioned controller functions as an “auto-peak device” that electronically adjusts the antenna beam pointing direction (the direction of the beam peak of the overall antenna, i.e., including the reflector) without the need for mechanical adjustment. The controller selects the subset of antenna elements in order to point and fine-tune the pointing of the beam as described herein. In other words, the switching elements (and optionally, other circuitry within circuit assembly 24) are responsive to control signals from the controller to activate the selected subset of the antenna elements. In doing so, the beam can be pointed and scanned for ease of installation and peaking during service. Notably, the fine tune pointing of the beam is fully-electronic, as no mechanical movement is required or performed in a typical embodiment.

As illustrated in FIG. 2, using the above-discussed switching scheme, different sets of antenna elements among the antenna elements of array 22 may be activated at different times to form beams that point in different directions. In this example, overlapping subsets 26 and 28 may be activated at different times to form beams that point in different directions 46 and 48, respectively. The center of the selected subset defines the direction of the beam. Thus, first selecting a first subset will point the beam in a first direction, and thereafter selecting a second subset will steer the beam from the first direction to a second direction.

When antenna 10 is first set up at a time of installation, a signal metric such as signal strength may be measured for each of a plurality of pointing directions of the beam formed with different respective sets of antenna elements in an iterative sequence. Based on the signal metric measurements, a final pointing direction and associated final set of antenna elements, typically with an optimized signal metric, may be selected for subsequent operation of antenna 10. These operations may be herein referred to as “auto-peaking”. Similar auto-peaking operations may be performed during the service life of antenna 10. For instance, auto-peaking may be performed periodically or may be triggered by an event such as the signal metric falling below a threshold. (It is noted here that for circularly polarized systems, a first set of antenna elements may form a first beam—such as the transmit beam—and when the sequence switches over to a second set of antenna elements, this may form a second beam—such as a receive beam—with a different pointing angle, which may be equivalent to adjusting the pointing direction of the first beam. This would allow to eliminate the circular polarization-induced beam squint inherently present in all offset-fed reflector antennas.)

In general, the far-field antenna pattern of the beam generated by antenna 10 can be understood as a Fourier transform of the electric field distribution (amplitude and phase) across the aperture of the reflector 30 The electric field distribution is due to the induced electric currents on the surface of the reflector 30 and may be correlated with the electric field of the “feed beam” pattern (the feed “illumination pattern”, which may or may not be a near-field illumination) incident across the reflector 30 surface. Thus, with knowledge of the feed beam pattern of a subset and the position of the subset with respect to reflector 30, the far-field radiation pattern of the overall antenna 10 may be computed, and candidate subsets may be determined.

Intuitively, relative pointing directions of beams generated using coplanarly shifted sets of antenna elements within array 22 may be understood as follows: For the case of an offset-fed reflector antenna, reflector 30 may be an asymmetrically-cut segment of a paraboloidal surface. (This is in contrast with center-fed reflector antennas, whose reflectors are cut symmetrically about the symmetry axis of the paraboloid.) Array 22 may be positioned with respect to reflector 30 such that a center point 82 of array 22 is located at the focal point F of reflector 30. A normal N1 to the planar surface of array 22, drawn from center point 82, may intersect reflector 30 at a central point of the projected aperture of reflector 30.

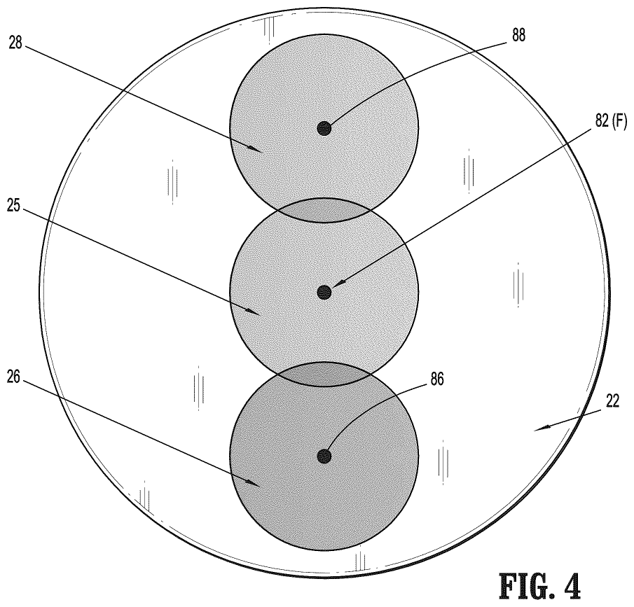

Referring momentarily to FIG. 4 and FIG. 2, another example subset (“cluster”) 25 of antenna elements is composed of antenna elements of array 22 substantially symmetric about point 82. If these are activated, the resultant beam may point in a direction N2, which may coincide with a central axis of reflector 30. This may be understood intuitively by equating the activated portion of array 22 as a single collective source substantially symmetric about the focal point F and radiating—i.e., projecting rays—towards reflector 30. With the collective source grouped about focal point F, all rays incident upon reflector 30 are reflected from the reflector in a mutually parallel manner, i.e., collimated, in a direction parallel to direction N2. By definition, in a collimated beam, the phase front of the electromagnetic wave is planar and perpendicular to the rays reflected from reflector 30. Further, the “feed beam”, i.e., the spatially combined radiated power of subset 25, may produce a substantially symmetrical amplitude distribution (electric field strength) across the aperture of reflector 30, which may in turn produce a rotationally symmetrical (pencil) beam from reflector 30. In order for the spatial combination of the power radiated by two or more radiating sources to take place, the following four conditions may be met simultaneously: (1) The radiating sources are located near one another in space; (2) the radiating sources are radiating at the same time; (3) the radiating sources are operating at the same, or almost the same (i.e., not orthogonal), frequencies; and (4) the radiating sources are radiating electromagnetic waves of the same polarization.

On the other hand, when subset (“cluster”) 26, whose center point 86 is displaced from the focal point F, is activated, subset 26 may be approximated as a collective source laterally shifted (in the plane of array 22) from focal point F. Due to the spatial combination of the power radiated by the individual elements of subset 26, this displaced collective source behaves as a single common antenna feed, such as a feed horn. The feed beam rays are incident upon the reflector 30 surface points at incident angles differing from the case above. Rays from subset 26 are therefore reflected from the surface of reflector 30 substantially collimated and in a direction non-parallel to direction N2. This produces an overall antenna beam with a peak direction 46 skewed from direction N2. In other words, the phase front of the electromagnetic wave reflected from the reflector is substantially planar and perpendicular to direction 46. Likewise, subset 28 with center point 88 is offset from the center point 82 on the opposite side with respect to subset 26 and may project a feed beam in direction 38 on the opposite side of normal N1, whereby antenna 10 produces a beam pointing in direction 48. (It is noted here that subsets 26 and 28 overlap in the example of FIG. 2 but do not overlap in the example of FIG. 4. The above discussion applies to both cases.)

In other embodiments, the center point 82 of array 22 is slightly offset from the focal point F. In still other embodiments, a center-fed reflector system is implemented, but has the drawback of the reflector aperture blockage by the feed and the feed support, which may lead to higher sidelobes and lower gain. With a center-fed reflector embodiment, similar beam pointing adjustments to those described herein may be made by selectively activating different sets of antenna elements within the array feed.

As discussed above, a selected set of antenna elements among array 22 is, in some embodiments, a subset of the antenna elements of array 22. Thus, array 22 may be considered an “oversized feed”. When antenna 10 operates with just a subset of array 22, antenna 10 may be considered a “thinned array-fed reflector”.

For a reflector 30 with a generally large F/D (focal length to aperture size), changing the angle between the center of the reflector 30 and the center of the selected subarray (the set or subset of antenna elements, e.g., subset 26) can result in the same or similar change in the angle of beam steering. In one example, changing the selected subarray so that its center is about 5 cm offset from the previously selected subarray can provide a 5 degrees scan.

It is further noted that in the examples herein, a single beam antenna is described. In other embodiments, multiple simultaneous beams may be formed using the same techniques described herein. Each of the simultaneous beams may have its pointing direction optimized by iteratively selectively activating subsets of array 22 associated with that beam, measuring a signal metric for each of the activated subsets, and selecting a final subset having the best performance.

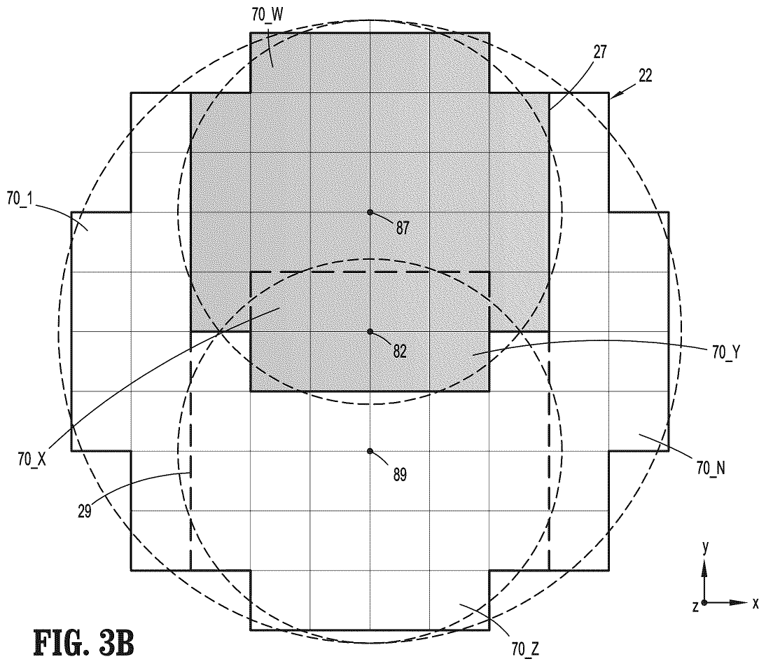

FIG. 3A shows examples of activatable subsets of antenna elements within the reflector feed array 22. Array 22 is exemplified as a planar array of N antenna elements, 70_1 to 70_N arranged to approximate a circular profile 122. Subsets 26 and 28 are exemplified as equal-sized, overlapping subsets approximating circular profiles 126 and 128, respectively. Subset 26 has a center point 86 offset to the left of the array 22 center point 82, and includes antenna elements 70_1 to 70_M. Subset 28 has a center point 88 offset to the right of center point 82, and may include an equal number of antenna elements 70_K to 70_N (where (N−K) equals (M−1)). Antenna elements 70 may be any suitable type of antenna element such as a microstrip patch element, a dipole, a slot, or an open ended waveguide. Centrally located antenna elements 70_K to 70_M are shared by subsets 26 and 28.

When the antenna elements of subset 26 are activated to form a beam just using subset 26, all remaining elements of array 22 are deactivated. Likewise, when the antenna elements of subset 28 are activated to form a beam just using subset 28, all remaining elements of array 22 are deactivated. Thus, in an iterative process to steer a beam and concurrently measure a signal metric, the antenna elements within differing peripheral regions of array 22 may be sequentially deactivated during a sequential activation of predetermined subsets.

FIG. 3B depicts further examples of activatable subsets of antenna elements within the reflector feed array 22. Subsets 27 and 29 with circular profiles have center points 87 and 89 offset to the top and bottom of array 22's center point 82, respectively. Subset 27 includes antenna elements 70_W to 70_Y arranged in a circular profile; subset 29 includes an equal number of circularly arranged antenna elements 70_X to 70_Z, where elements 70_X to 70_Y are shared between subsets 27 and 29. Subsets 27 and 29 may each have an equal number of antenna elements as those of subsets 26 and 28. Additional activatable subsets interpolated between those of subsets 26-29 may be similarly formed. Further activatable subsets may include a central subset (e.g., circular and the same size as subsets 26-29) symmetrical about the array 22's center point 82; and additional subsets incrementally formed between the central subset and any other subset that extends to an edge of array 22, such as any of subsets 26-29. Subsets of different sizes within array 22 may also be formed. As mentioned earlier, FIG. 4 is an example showing a centrally arranged subset 25 that overlaps smaller aperture versions of subsets 26 and 28 (the example subsets 26 and 28 do not overlap in FIG. 4).

An advantage of using generally circular subsets of antenna elements as described above in conjunction with reflector 30 having a circular profile is that the feed illumination pattern from a circular aperture is generally the same in any direction across the diameter. Alternatively, feeds and subsets of different shapes, e.g., square, rectangular or oval, may be substituted. In another embodiment, array 22 is configured as a single linear array or a set of crossed linear arrays. Reflector 30 may alternatively have an oval or other shaped profile.

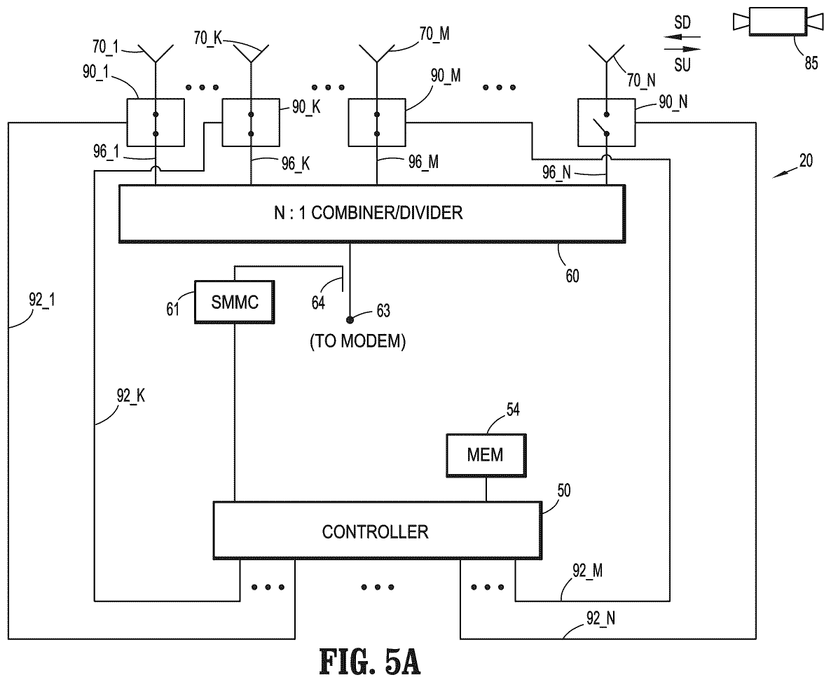

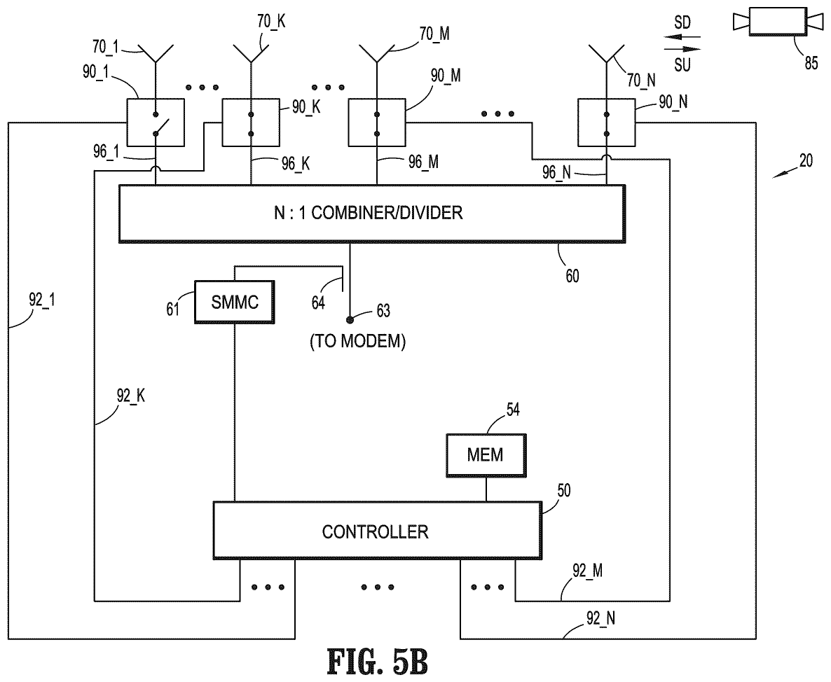

FIG. 5A schematically illustrates example components of antenna feed 20. Antenna feed 20 may include antenna elements 70_1 to 70_N; an N:1 combiner/divider 60; RF front end elements (FEEs) 90_1 to 90_N; a controller 50; signal metric measurement circuitry (SMMC) 61, a coupler 64 and memory 54.

Combiner/divider 60 is configured to divide and/or combine signals, depending on whether antenna 10 is configured as a transmitting antenna system, a receiving antenna system, or both a transmitting and receiving antenna system. In the transmit direction, combiner/divider 60 divides an input RF transmit (uplink) signal at an RF input/output (I/O) port 63 into N divided transmit signals provided at transmission lines 96_1 to 96_N. The transmit signals are routed through selected ones of FEEs 90 and antenna elements 70 to generate an uplink signal SU which is transmitted to a target device, e.g., a satellite 85. (Note that the outputs of FEEs 90 may be electrically connected to respective antenna elements 70. Alternatively, FEEs 90 are electromagnetically (EM) coupled to respective antenna elements 70 via a suitable EM excitation mechanism.) In the receive direction, combiner/divider 60 combines up to N “element signals” received by antenna elements 70, each derived from a downlink signal SD from target device 85, and provides a combined signal at I/O port 63. Some examples of satellite 85 include a low earth orbit (LEO) satellite, a medium earth orbit (MEO) satellite, a geosynchronous equatorial orbit (GEO) satellite, or an elliptical orbit satellite.

Combiner/divider 60, transmission lines 96, and FEEs 90 collectively form a feed network of feed 20. Each FEE 90_i (i=any of 1 through N) may include a switching element (e.g., an amplifier or a series connected switch, described below) controlled by controller 50 to activate/deactivate an associated antenna element 70_i. In this manner, candidate subsets of antenna elements are selectively activated. For instance, in the example illustrated in FIG. 5A, subset 26 of FIG. 3A may be activated by closing the switching elements in FEEs 90_1 to 90_M and thereby activating antenna elements 70_1 to 70_M, and opening the remaining switching elements (e.g., in FEE 90_N, etc.) coupled to the remaining antenna elements 70. On the other hand, FIG. 5B shows switching states of switching elements in an example for activating subset 28, by closing the switching elements in FEEs 96_K to 96_N to thereby activate antenna elements 70_K to 70_N, and opening the switching elements in the FEEs coupled to the remaining antenna elements 70. In the receive direction, when a subset having M elements is activated, N:1 combiner/divider 60 effectively acts as an M:1 combiner, since there are no element signals incident upon the output ports that are not coupled to any of the M elements.

It is further noted here that in an exemplary embodiment, the feed network composed of combiner/divider 60, transmission lines 96 and FEEs 90 are configured to “drive” antenna elements 70 in a fixed phase relationship among the antenna elements for each of the candidate subsets, which is typically an in-phase relationship. In some embodiments, the fixed phase relationship is achieved by having the electrical length (or insertion phase) of a signal path from port 63 to antenna element 70_1 be the same as the electrical length from port 63 to any of the other antenna elements, such that all of the antenna elements are driven in phase. (Here, “drive” applies to both the transmit and receive directions.) When the antenna elements of any subset are driven in phase, a pencil beam should be formed with a pointing direction (and beam peak) aligned with a normal to the plane of the subset (more precisely, the pointing direction should be aligned with a normal to a center point of the subset).

On the other hand, other embodiments may implement a built in phase gradient across the aperture if desired, in which case the fixed phase relationship is not an equal phase relationship. Still other embodiments employ phase shifters within the FEEs 90 or elsewhere (e.g., within combiner/divider 60) to enable dynamic steering of the feed beam and hence the antenna 10 beam to enable further fine tuning of the pointing direction. This approach, however, adds to the complexity and cost of the feed 20. Embodiments that omit phase shifters have a manufacturing and cost advantage over those employing phase shifters.

Coupler 64 may couple receive path signal energy to signal metric measurement circuitry (SMMC) 61 to allow SMMC 61 to measure a signal metric, typically signal strength, signal to noise ratio (SNR), signal to interference and noise (SINR) or any combination thereof. (Other examples include Energy per bit/Noise-spectral density (EbNo), Energy per symbol/Noise-spectral density (EsNo), Error Vector Magnitude (EVM), Bit Error Rate (BER), or any combination thereof.) SMMC 61 may provide the signal metric measurement result to controller 50. As discussed later, controller 50 may base a decision to select one of the candidate subsets as a final subset of antenna elements for subsequent operations of antenna 10. Controller 50 may include at least one processor that reads and executes program instructions from memory 54 coupled thereto to carry out its operations. Memory 54 may also store the signal metric measurement results. As noted earlier, controller 50 may be disposed within circuit assembly 24 in close proximity to antenna array 22, but is alternatively disposed elsewhere within reflector antenna 10, or is disposed remotely. In either of these cases, controller 50 may be considered a component of feed 20.

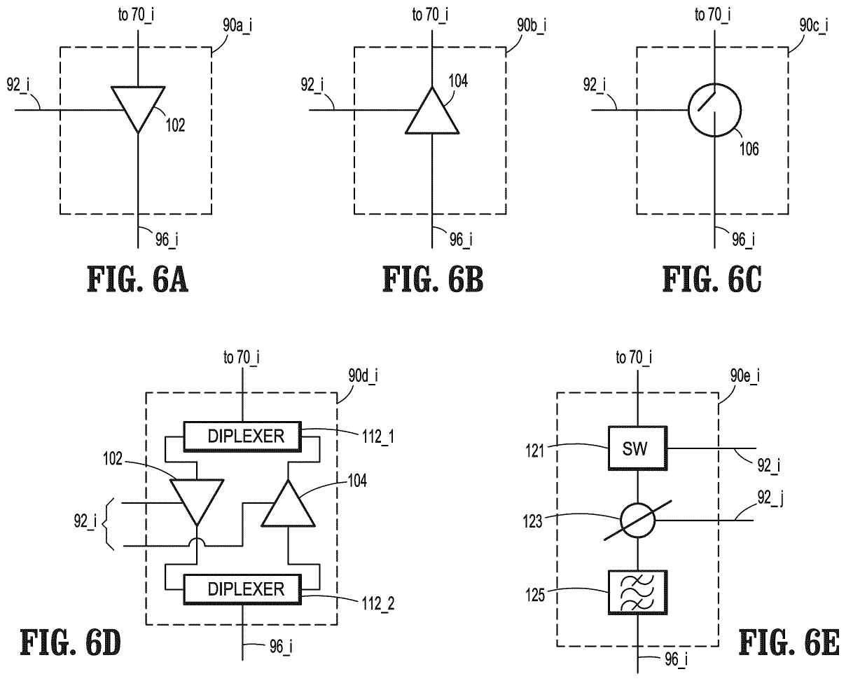

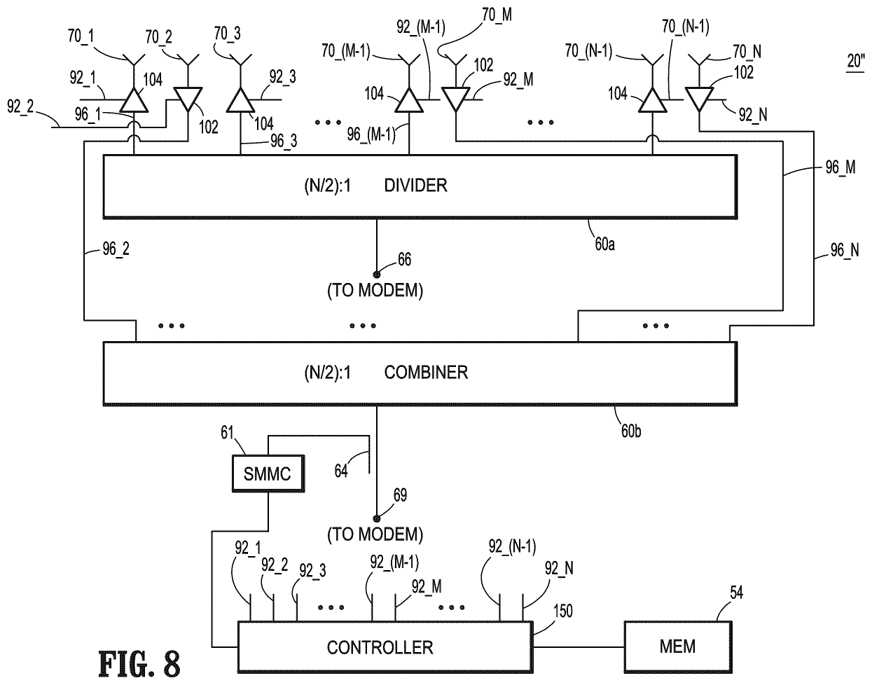

FIGS. 6A-6E depict respective examples of front end elements (FEEs) in antenna feed 20. Each example shows an FEE that may be used for any of FEEs 90_1 to 90_N. FIG. 6A shows a receive path example for a case in which antenna 10 is a receiving antenna system, or, antenna array 22 is an interleaved transmitting and receiving array (described below in connection with FIG. 8). Here, an FEE 90a_i includes a low noise amplifier (LNA) 102 serving as the FEE switching element. LNA 102 is coupled between an antenna element 70_i and a transmission line 96_i. To turn the switching element of FEE 90a_i on and thereby activate antenna element 70_i, a bias voltage is supplied by controller 50 to LNA 102 on control line 92_i, enabling LNA 102 to function normally to amplify an element signal provided by antenna element 70_i. To deactivate antenna element 70_i, the bias voltage is withdrawn by controller 50 in a manner sufficient to turn off LNA 102. The bias voltage may be withdrawn either by floating control line 92_i open or tying control line 92_i to a different voltage, e.g., a ground voltage, sufficient to turn off LNA 102. As a result, the element signal does not pass to transmission line 96_i. Accordingly, LNA 102 is controlled to have a dual function as both an amplifier and a switch (i.e., an antenna element activation/deactivation switch).

FIG. 6B shows a transmit path example for the case in which in which antenna 10 is a transmitting antenna system, or, antenna array 22 is an interleaved transmitting and receiving array. Here, an FEE 90b_i includes a power amplifier (PA) 104 serving as the FEE switching element. PA 104 is coupled between antenna element 70_i and transmission line 96_i, that is on-off controlled by supplying/withdrawing a bias voltage in the same way as described above for LNA 102. When PA 104 is normally biased, a transmit signal on line 96_i is amplified and routed to antenna element 70_i, and when PA 104 is turned off by withdrawing the bias voltage, the transmit signal does not pass to antenna element 70_i.

FIG. 6C shows a transmit path or receive path example in which an FEE 90c_i is embodied as an in-line switch 106 such as a PIN diode switch coupled between antenna element 70_i and transmission line 96_i. Switch 106 is switched on (closed) by an on-voltage supplied on line 92_i to thereby activate antenna element 70_i. Switch 106 is switched off (opened) by an off-voltage on line 92_i to deactivate antenna element 70_i. Another example of switch 106 is a variable attenuator controllable, e.g., to have attenuation in the range of ˜0 dB to 20 dB. Still another example of switch 106 is a modulation modifier that may, e.g., provide variable attenuation in the range of ˜0 dB to 20 dB.

FIG. 6D shows a transmit and receive path example in which an FEE 90d_i includes a PA 104 and an LNA 102 connected in parallel between first and second diplexers 112_1 and 112_2, which enables both transmit path and receive path signals to flow between antenna element 70_i and transmission line 96_i simultaneously. Control lines 92_i in this case may include a first control line supplying a first bias voltage to PA 104 and a second control line supplying a second bias voltage to LNA 102. The first and second bias voltages may be concurrently supplied to activate antenna element 70_i in a subset of antenna elements allocated for both transmit and receive operations. The first and second bias voltages may be concurrently withdrawn to deactivate antenna element 70_i for both transmit and receive. It is also possible to activate antenna element 70_i on transmit and deactivate antenna element 70_i on receive, or vice versa. For instance, if different respective frequencies are used for transmit and receive, a first subset of antenna elements 70 may be optimal on transmit whereas a second subset may be optimal on receive. In this case, if antenna element 70_i is a member of only one of the first and second subsets, it may be activated on transmit and deactivated on receive, or vice versa.

FIG. 6E illustrates that additional RF front end components may be included in any given FEE 90. For instance, FEE 90e_i includes a switch 121 in series with a phase shifter 123 and/or a filter 125. Switch 121 may be any one of PA 104, LNA 102, in-line switch 106, or the combination of components within FEE 90d_i of FIG. 6D. Switch 121 is on-off controlled via control line 92_i to activate/deactivate antenna element 70_i as described above for FIGS. 6A-6D. Filter 125 may be a band pass, high pass or low pass filter. Phase shifter 123 may have its insertion phase controlled via a command from controller 50 on control line 92_j. By employing a phase shifter 123 behind every antenna element 70, a controllable phase gradient may be applied across any candidate subset, which provides further beam peak adjustment capability. However, such further adjustment capability is added at the expense of additional complexity to feed 20. One or more further components such as an upconverter and/or a downconverter may be further included in FEE 90e_i (or may alternatively be coupled between port 63 and combiner/divider 60).

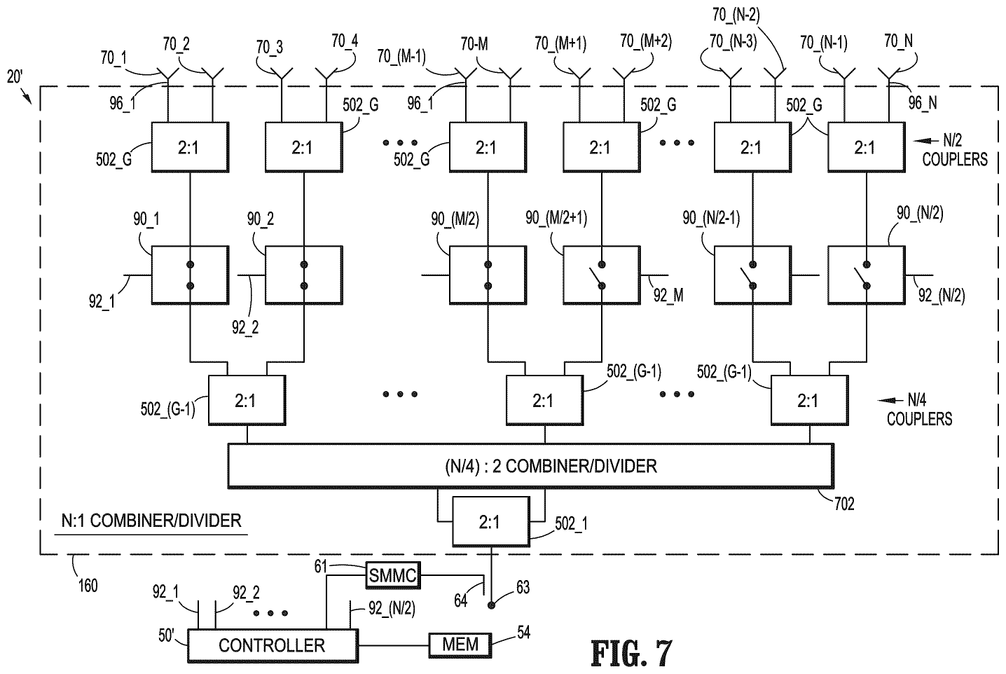

FIG. 7 schematically illustrates another example of an antenna feed, 20′, that may be employed in the reflector antenna 10, according to another embodiment. Feed 20′ utilizes a smaller number of FEEs 90 than feed 20 described above, where each FEE 90 within feed 20′ is coupled to two or more antenna elements 70 to control activation/deactivation thereof. Feed 20′ includes an N:1 combiner/divider 160 that performs the same functionality as N:1 combiner/divider 60 discussed above, with the exception of the smaller number FEEs 90 being included within combiner/divider 160. Thus, in the transmit direction, combiner/divider 160 divides an input RF transmit signal at RF I/O port 63 into N divided transmit signals provided at transmission lines 96_1 to 96_N, where the divided transmit signals are routed directly to antenna elements 70_1 to 70_N to generate uplink signal SU. In the receive direction, combiner/divider 160 combines up to N element signals directly provided by antenna elements 70_1 to 70_N and provides a combined receive signal at I/O port 63.

In the example of FIG. 7, the number of FEEs within feed 20′ is reduced from N to N/2 as compared to feed 20. To this end, combiner/divider 160 may include “G” hierarchical levels of combiner/dividers, such as 3 dB couplers 502_1 to 502_G, interchangeably called 2:1 combiner/dividers. A first set (highest level set) of 3 dB couplers is a single coupler 502_1 connected to I/O port 63; a last set (lowest level set) contains N/2 couplers 502_G; a next to last set contains N/4 couplers 502_(G−1); and sets therebetween (if any, depending on the value of N) are arranged within an (N/4):2 combiner/divider 702 between coupler 502_1 and the set of 502_(G−1) couplers. FEEs 90_1 to 90_(N/2) may be controlled by controller 50′ in the same way as for feed 20 described above, and other aspects of feed 20′ may be the same as described above for feed 20.

The switching states of FEEs 90 in FIG. 7 are for the example of activating antenna elements 70_1 to 70_M of subset 26 of FIG. 3A and deactivating remaining antenna elements 70_(M+1) to 70_N of array 22. Thus, the switching states of FEEs 90_1 to 90_(M/2) are on and the switching states of FEEs 90_(M+1) to FGEE 90_N are off. In other embodiments, more or fewer FEEs 90_1 to 90_(N/2) may be included, e.g., by arranging the FEEs between different levels of combiner/dividers 502. For instance, FEEs 90 could be alternatively arranged between the sets of couplers 502_(G−1) and 502_1 to group more than two antenna elements 70 with each FEE 90 and reduce the number of FEEs further. The number of FEEs 90 and their arrangement may depend on the number N of antenna elements 70 within array 22, the number of antenna elements 70 within each subset such as 26-29, the shape of each subset, and whether it is desirable to group more antenna elements per each FEE 90 within each of the subsets.

Additionally or alternatively, in some embodiments, distributed amplifiers/phase shifters/filters are unnecessary (e.g., one or more amplifiers behind every antenna element 70, or behind every group of antenna elements 70, is unnecessary). In this case, if some of the N antenna elements 70_1 to 70_N are common to all candidate subsets of antenna elements 70 and are therefore always activated, FEEs 90 may be omitted in all paths coupled to those antenna elements 70, and may be included in each path, or for each group of paths, coupled to the remaining antenna elements. For example, in some applications, a single low noise amplifier (LNA) or transmit side amplifier (both not shown), coupled to port 63, may be utilized for the entire array 22.

FIG. 8 schematically illustrates example components of an alternative antenna feed 20″ that may be employed within reflector antenna 10 of FIG. 1. Feed 20″ includes interleaved transmit and receive antenna elements 70_1 to 70_N, in which some of the antenna elements 70 are transmit antenna elements (“transmit elements”) dedicated for transmitting signals and the remaining antenna elements are receive antenna elements (“receive elements”) dedicated for receiving signals. The transmit and receive elements are arranged in an interleaving pattern that may vary from embodiment to embodiment. In one example, an alternating interleaving pattern may include transmit and receive elements alternating within rows and/or columns. For instance, as illustrated in the layouts of FIGS. 3A and 8, subset 26 may include, in a common row, a transmit element 70_1 adjacent to a receive element 70_2 one column to the right, which is in turn adjacent to a transmit element 70_3, and so on. A staggered arrangement may also be implemented in which elements in the same column differ from row to row. For example, antenna element 70_Q in FIG. 3A directly above transmit element 70_2 is a receive element.

As depicted in FIG. 8, an (N/2):1 divider 60a may be divide an RF transmit signal input to a port 66 into N/2 divided transmit signals, each coupled to one of the N/2 transmit elements 70_1, 70_3, . . . 70_(N−1) through a power amplifier (PA) 104 functioning as a front end element (FEE) 90 as described above. Alternatively, a switch 106 or FEE 90e_i (see FIGS. 6C and 6E) is substituted for each PS 104. Likewise, an (N/2):1 combiner 60b may combine (N/2) element signals from the receive elements 70_2, 70_4, . . . , 70_N into a combined receive signal that is output to a modem at port 69. In the example of FIG. 8, the element signals are first amplified by LNAs 102, each coupled between one of the receive elements and an output port of combiner 60b. Alternatively, a switch 106 or FEE 90e_i is substituted for each LNA 104. Coupler 64 may couple a portion of the combined receive signal to SMMC 61, which may function in the same way as described above to measure a signal metric and output measured results to controller 150. Controller 150 is configured to control the activation/deactivation of antenna elements 70 by outputting/withdrawing bias voltages to the PAs 104 and LNAs 102 on control lines 92_1 to 92_N. Other aspects of feed 20′ may be the same as described above for feed 20.

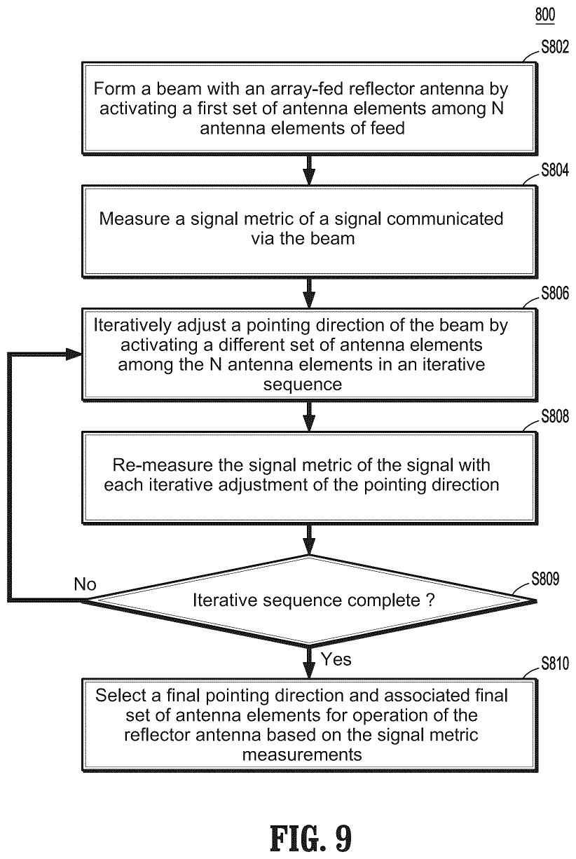

FIG. 9 is a flow diagram of a method, 800, for adjusting a pointing direction of an antenna beam, according to an embodiment. The operations of method 800 may be executed by controller 50 or 150 controlling the formation of an antenna beam of reflector antenna 10, in cooperation with signal metric measurement circuitry (SMMC) 61 performing signal metric measurements on a signal received from a target.

Following manual installation of an array-fed reflector antenna 10 and an optional coarse mechanical adjustment of the reflector antenna to coarsely point the beam at a target, a beam may be formed with the reflector antenna by activating a first set of antenna elements (e.g., subset 26) among N antenna elements (e.g., 70_1 to 70_N) of the antenna feed (e.g., 20 or 20′) (S802). A signal metric of a signal communicated by the beam may then be measured (S804). Typically, this is performed by SMMC 61 on a received (downlink) signal SD from the target (e.g., satellite 85). Alternatively, it is possible to measure the signal metric at the target, by measuring a signal transmitted by antenna 10. In this case, the signal metric measurement data is routed to the controller 50, 50′ or 150 by a suitable link and method.

Once a signal metric associated with the first set of antenna elements is obtained, method 800 may iteratively adjust a pointing direction of the beam by activating a different set of antenna elements among the N antenna elements in an iterative sequence (S806). Various types of optimization algorithms may be used for the iterative procedure, where the algorithm selected may depend on the number of antenna sets to be sequentially activated. The signal metric of the signal may then be re-measured with each iterative adjustment of the pointing direction (S808). When the iterative sequence is completed (Y outcome of S809), a final pointing direction and associated final set of antenna elements may be selected for operation of the reflector antenna based on the signal metric measurements (S810). For instance, the subset of antenna elements with the highest signal metric may be selected as the final set.

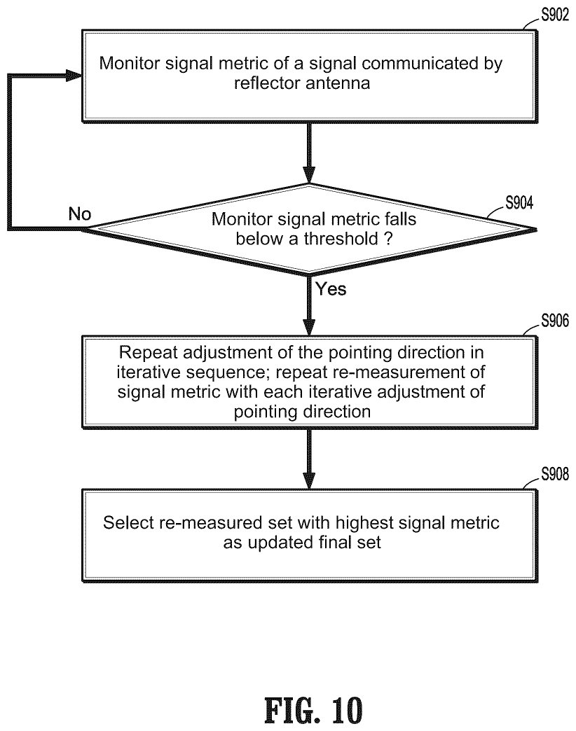

FIG. 10 is a flow diagram depicting further example pointing direction adjusting operations in the method 800 of FIG. 9, which may occur subsequent to an initial set-up (subsequent to operation S810). With these operations, the signal metric of a signal communicated by the reflector antenna 10 with the target may be monitored (S902). The monitored signal metric may be compared to a threshold (S904), and if it falls below the threshold (Y outcome of S904), the above-described iterative sequence may be repeated. Thus, the adjustment of the pointing direction in the iterative sequence may be repeated, where the signal metric is re-measured with each iterative adjustment (S906). Upon completion of the re-measurements, the set of antenna elements having the highest signal metric may be re-selected as the final set of antenna elements for subsequent operation of the reflector antenna (S908).

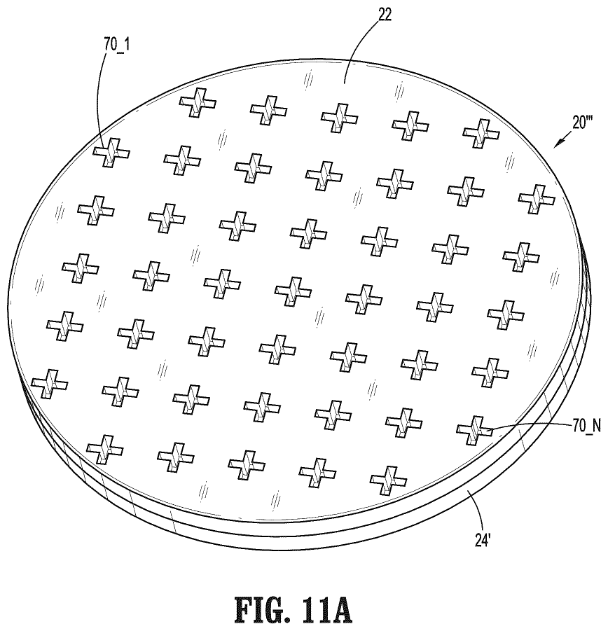

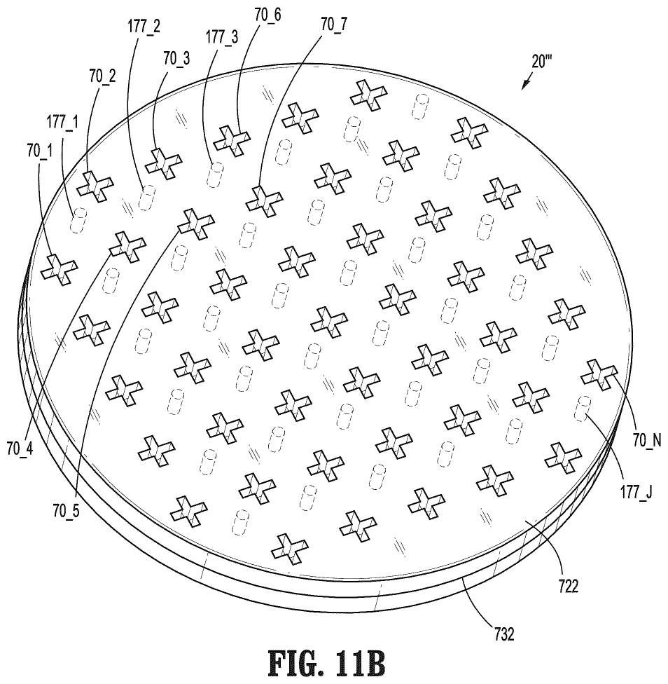

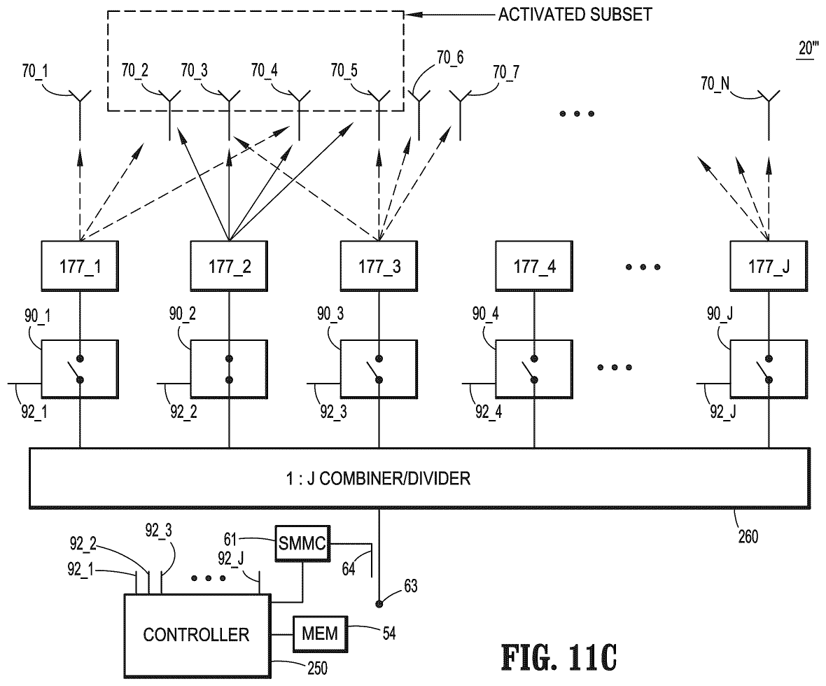

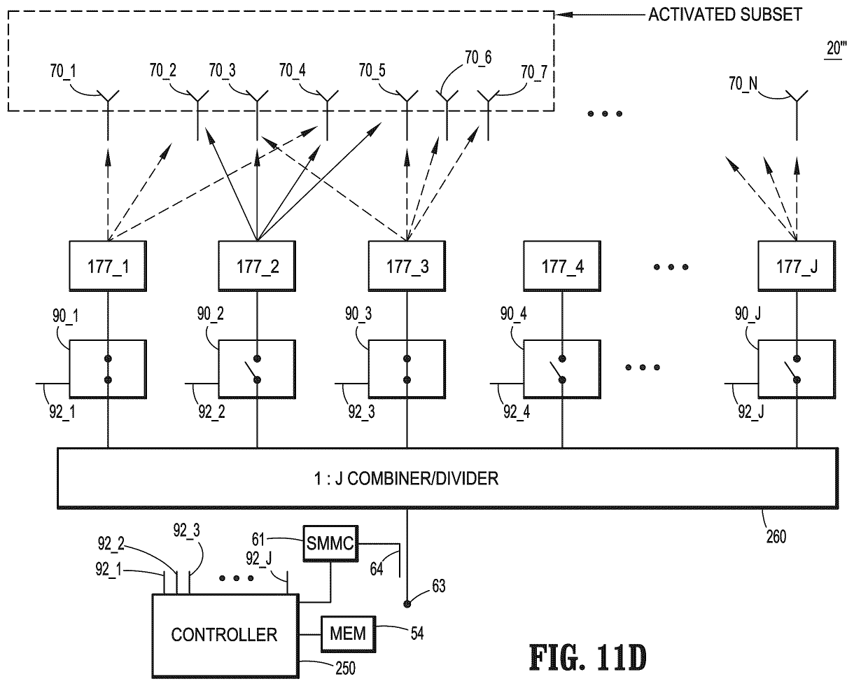

FIG. 11A is a perspective view of an antenna feed, 20″, which is an example of antenna feed 20 deployable within reflector antenna 10. FIG. 11B depicts antenna feed 20″ with internal excitation couplers, which implements spatially overlapping beamforming according to an embodiment. Referring to FIGS. 11A and 11B, antenna feed 20′″ may include another example antenna array 22 having a plurality of slotted antenna elements 70_1 to 70_N (where N is any suitable integer); a circuit assembly 24′ behind antenna array 22, and a plurality J of electromagnetic (EM) couplers 177_1 to 177_J, where J<N.

The structure of antenna feed 20″ forming the slotted antenna elements 70 may be in the form of a hollow disc with a patterned upper surface 722 to form the antenna elements 70, and a patterned lower surface 732 with openings allowing couplers 177 to protrude. Each coupler 177 may be an excitation pin that electromagnetically (EM) couples signal energy to/from at least two antenna elements 70 that at least partially surround the excitation pin. (Each coupler 177 may protrude from one of the openings in bottom surface 732 and extend to a point below the upper surface 722.) For example, peripherally located coupler 177_1, when is partially surrounded by antenna elements 70_1, 70_2 and 70_4 and, when excited (discussed below), couples signal energy to/from these antenna elements. More centralized located elements may couple energy to four surrounding antenna elements in the example. For instance, coupler 177_2, when excited, couples signal energy to/from surrounding antenna elements 70_2, 70_3, 70_4 and 70_5. Because adjacent couplers such as 177_1 and 177_2 are capable of coupling signal energy to some of the same antenna elements, e.g., 70_2 and 70_4, respectively, feed 22 may be characterized as a feed that implements spatially overlapping beamforming.

FIG. 11C is a schematic diagram of the antenna feed of FIG. 11B according to an embodiment, and illustrates a first example of how a subset of antenna elements may be activated. Antenna feed 20″ may further include J front end elements (FEEs) 90_1 to 90_J connected to couplers 177_1 to 177_J, respectively, each of which may be configured as discussed above to include at least one switching element. A controller 250 may control the switching states of FEEs 90_1 to 90_J through voltages applied on control lines 92_1 to 92_J. A 1:J combiner/divider 260 may be coupled between FEES 90 and I/O port 63. Coupler 61, SMMC 64 and memory 54 may operate as described above. In the example of FIG. 11C, based on the layout of FIG. 11B, coupler 177_1 is EM coupled to antenna elements 70_1, 70_2 and 70_4; coupler 177_2 is EM coupled to antenna elements 70_2 to 70_5; coupler 177_3 is EM coupled to antenna elements 70_3 and 70_5 to 70_7; and so forth.

In an example in which it is desired to activate small subsets of antenna elements in the iterative activation sequence described above, only one of FEEs 90_1 to 90_J may be switched on at a time, to thereby activate the antenna elements 70 coupled thereto via the connected coupler 177. In FIG. 11C, FEE 90_2 is switched on while the remaining FEEs, FEE 90_1 and 90_3 to 90_N are switched off. As a result, antenna elements 70_2 to 70_5 are activated and form an activated subset, whereas the remaining antenna elements, 70_1 and 70_6 to 70_N are deactivated.

FIG. 11D illustrates another activation method for antenna feed 20′″, in which a larger subset of antenna elements may be activated. Here, FEEs 90 connected to two or more non-adjacent couplers 177 may be switched on concurrently, to thereby activate a cluster of antenna elements 70 EM coupled to the non-adjacent couplers. In the shown example, FEEs 90_1 and 90_3 are switched on while the remaining FEEs are switched off. Accordingly, based on the layout of FIG. 11B, antenna elements 70_1 to 70_7 form an activated subset.

Many variations in the layout of FIGS. 11A and 11B are available, such that more or fewer groups of antenna elements may be simultaneously activated to form desired subsets for optimizing the antenna 10's beam pointing angle as described above. Moreover, other types of spatially overlapped beamforming may be implemented.

The various illustrative logical blocks, engines, and circuits described in connection with the present disclosure may be implemented or performed with processing circuitry within any of the reflector antennas (e.g., within controller 50, 50′, 150 or 250), that may read and execute instructions from a non-transitory recording medium (e.g., memory 54). The processing circuitry may include a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, functions described above may be implemented using hardware, software, firmware, or any combination thereof. If implemented in software, the functions may be stored as one or more instructions or code on a non-transitory computer-readable medium (e.g., memory 54). Examples of a computer-readable medium include both computer storage media and communication media including any medium that facilitates transfer of a computer program from one place to another. A storage medium may be any available medium that can be accessed by a computer/processing circuitry. Examples of such computer-readable media include RAM, ROM, EEPROM or any other medium that can be used to store desired program code in the form of instructions or data structures and that can be accessed by a computer/processing circuitry.

While the technology described herein has been particularly shown and described with reference to example embodiments thereof, it will be understood by those of ordinary skill in the art that various changes in form and details may be made therein without departing from the spirit and scope of the claimed subject matter as defined by the following claims and their equivalents.

1. A method for adjusting a pointing direction of an antenna beam, the method comprising:
forming a beam with a reflector antenna comprising a reflector and a feed including a planar array of N antenna elements, by activating a first set of antenna elements among the N antenna elements;
measuring a signal metric of a signal communicated via the beam;
iteratively:
adjusting a pointing direction of the beam at least in part by activating a different set of antenna elements among the N antenna elements; and
re-measuring the signal metric of the signal with each iterative adjustment of the pointing direction; and
selecting a final pointing direction and associated final set of antenna elements for operation of the reflector antenna based on the signal metric measurements.

2. The method of claim 1, wherein the first set and different sets include common antenna elements.

3. The method of claim 1, wherein the first set and the different sets are composed of mutually exclusive ones of the antenna elements.

4. The method of claim 1, wherein the feed includes an input/output port, and a feed network coupled between the input/output port and the antenna elements, the feed network including a plurality of front end elements, each coupled to at least one of the antenna elements and each having a switching element for selectively activating and deactivating the at least one of the antenna elements.

5. The method of claim 4, wherein the switching element of each front end element of the plurality of front end elements is at least one amplifier, the at least one amplifier being turned on and off to activate and deactivate, respectively, the at least one antenna element coupled to the front end element.

6. The method of claim 4, wherein the switching element of each front end element of the plurality of front end elements is a series connected switch, the switch being closed and opened to activate and deactivate, respectively, the at least one antenna element coupled to the front end element.

7. The method of claim 1, wherein antenna elements located within at least one peripheral region of the planar array are deactivated and at least some of remaining antenna elements of the planar array are activated to form at least one of the first and different sets of activated antenna elements.

8. The method of claim 1, wherein antenna elements within peripheral regions of the planar array on opposite sides are sequentially deactivated during a sequential activation of differing sets of the antenna elements.

9. The method of claim 1, wherein the reflector antenna is a ground-based antenna, and the signal communicated via the beam is a satellite signal received by the reflector antenna.

10. The method of claim 1, wherein the signal metric is signal strength, signal to noise ratio (SNR), signal to interference and noise ratio (SINR), Energy per bit/Noise-spectral density (EbNo), Energy per symbol/Noise-spectral density (EsNo), Error Vector Magnitude (EVM), Bit Error Rate (BER), or any combination thereof.

11. The method of claim 1, wherein sets of the antenna elements are individually activated and deactivated by controlling front end elements each arranged between first and second sets of combiner/dividers, each combiner/divider of the first and second sets of combiner/dividers coupled to a respective group of at least two of the antenna elements.

12. The method of claim 1, further comprising maintaining the feed at a stationary position relative to the reflector throughout a time of said forming the beam and the selecting of the final pointing direction.

13. The method of claim 1, further comprising:
during operation of the reflector antenna using the final set of antenna elements, monitoring signal metric of a signal communicated by the reflector antenna;
when the monitored signal metric falls below a threshold, repeating the iterative adjustment of the pointing direction and re-measurement of the signal metric with each iterative adjustment; and
selecting the re-measured set having a highest signal metric as an updated final set for operation of the reflector antenna.

14. The method of claim 1, wherein:
the planar array of antenna elements comprises transmit antenna elements and receive antenna elements interleaved with the transmit antenna elements; and
the feed comprises an (N/2):1 divider coupled to the transmit antenna elements, and an (N/2):1 combiner coupled to the receive antenna elements.

15. The method of claim 1, wherein the feed includes a plurality of electromagnetic (EM) couplers, each arranged to couple signal energy simultaneously to at least two of the antenna elements.

16. The method of claim 15, wherein the feed further comprises a plurality of front end elements, each including a switching element and each coupled to one of the EM couplers, wherein the at least two of the antenna elements are activated when the switching element is closed.

17. A reflector antenna comprising:
a reflector and a feed including a planar array of N antenna elements, the feed being positioned to illuminate the reflector;
a combiner/divider coupled between the N antenna elements and an input/output port of the reflector antenna;
signal metric measurement circuitry; and
a controller cooperating with the signal metric measurement circuitry, said controller configured to:
activate a first set of antenna elements among the N antenna elements and thereby cause the reflector antenna to form a beam;
measure a signal metric of a signal communicated via the beam;
iteratively:
adjust a pointing direction of the beam at least in part by activating a different set of antenna elements among the N antenna elements; and
re-measure the signal metric of the signal with each iterative adjustment of the pointing direction; and
select a final pointing direction and associated final set of antenna elements for operation of the reflector antenna, based on the signal metric measurements.

18. The reflector antenna of claim 17, wherein the reflector antenna further comprises a support pier for mounting the reflector antenna to a surface, and a mounting bracket assembly configured for initially adjusting a pointing direction of the reflector relative to the surface.

19. The reflector antenna of claim 17, wherein each iterative different set of antenna elements has a different center point on the planar array.

20. The reflector antenna of claim 17, wherein the reflector is offset-fed by the feed, the reflector antenna thereby being an offset-fed reflector antenna.

21. The reflector antenna of claim 17, wherein the first set and different sets include common antenna elements.

22. The reflector antenna of claim 17, wherein the first set and the different sets are composed of mutually exclusive ones of the antenna elements.

23. The reflector antenna of claim 17, wherein the feed includes the input/output port, and a feed network coupled between the input/output port and the antenna elements, the feed network including a plurality of front end elements, each coupled to at least one of the antenna elements and each having a switching element configured for selectively activating and deactivating the at least one of the antenna elements.

24. The reflector antenna of claim 23, wherein the switching element of each front end element of the plurality of front end elements is at least one amplifier, the at least one amplifier configured to be turned on and off to activate and deactivate, respectively, the at least one antenna element coupled to the front end element.

25. The reflector antenna of claim 23, wherein the switching element of each front end element of the plurality of front end elements is a series connected switch, the switch configured to be closed and opened to activate and deactivate, respectively, the at least one antenna element coupled to the front end element.

26. The reflector antenna of claim 17, wherein antenna elements located within at least one peripheral region of the array are configured to be deactivated and at least some of remaining antenna elements of the array are configured to be activated to form at least one of the first and different sets of activated antenna elements.

27. The reflector antenna of claim 17, wherein antenna elements within peripheral regions of the array on opposite sides are configured to be sequentially deactivated during a sequential activation of differing sets of the antenna elements.

28. The reflector antenna of claim 17, wherein the reflector antenna is a ground-based antenna, and the signal communicated via the beam is a satellite signal received by the reflector antenna.

29. The reflector antenna of claim 17, wherein the signal metric is signal strength, signal to noise ratio (SNR), signal to interference and noise ratio (SINR), Energy per bit/Noise-spectral density (EbNo), Energy per symbol/Noise-spectral density (EsNo), Error Vector Magnitude (EVM), Bit Error Rate (BER), or any combination thereof.

30. The reflector antenna of claim 17, wherein the combiner/divider comprises a first set of combiner/dividers and a second set of combiner/dividers and sets of the antenna elements are individually activated and deactivated by controlling front end elements each arranged between the two sets of combiner/dividers, each of the first and second sets of combiner/dividers coupled to a respective group of at least two of the antenna elements.

31. The reflector antenna of claim 17, wherein the feed is maintained at a stationary position relative to the reflector throughout a time that the beam is formed and the final pointing direction is selected.

32. The reflector antenna of claim 17, wherein the controller further cooperates with the signal metric measurement circuitry, said controller further configured to:
during operation of the reflector antenna using the final set of antenna elements, monitor the signal metric of a signal communicated by the reflector antenna;
when the monitored signal metric falls below a threshold, repeat the iterative adjustment of the pointing direction and re-measurement of the signal metric with each iterative adjustment; and
select the re-measured set having a highest signal metric as an updated final set for operation of the reflector antenna.

33. The reflector antenna of claim 17, wherein:
the array of antenna elements comprises transmit antenna elements and receive antenna elements interleaved with the transmit antenna elements; and
the feed comprises an (N/2):1 divider coupled to the transmit antenna elements, and an (N/2):1 combiner coupled to the receive antenna elements.

34. The reflector antenna of claim 17, wherein the feed includes a plurality of electromagnetic (EM) couplers, each arranged to couple signal energy simultaneously to at least two of the antenna elements.

35. The reflector antenna of claim 34, wherein the feed further comprises a plurality of front end elements, each including a switching element and each coupled to one of the EM couplers, wherein the at least two of the antenna elements are configured to be activated when the switching element is closed.

36. The method of claim 1, wherein each iterative different set of antenna elements has a different center point on the planar array.
